(19) United States
(12) Patent Application Publication
(10) Pub. No.: US 2010/0315326 A1
(43) Pub. Date: Dec. 16, 2010

(54) ELECTRONIC PAPER DISPLAY WHITESPACE UTILIZATION

(76) Inventors: Vincent Le Chevalier, San Jose, CA (US); Brady Duga, Carlsbad, CA (US); Garth Conboy, La Jolla, CA (US); William Leshner, San Diego, CA (US); Ruze Richards, Holmdel, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/482,013

(22) Filed: Jun. 10, 2009

(51) Int. Cl. G09G 3/34

(52) U.S. Cl. 345/107

(57) ABSTRACT

A system for and method for electronic paper display device content formatting is presented. The system and method may include receiving an electronic request to format electronic paper display device content at an a network accessible device, determining remaining available display space on a page view of a electronic paper display associated with an electronic paper display device, identifying additional electronic content for inclusion in the page view based at least in part on a comparison of one or more attributes of the additional electronic content with the determined remaining available display space, and adding the identified additional electronic content to the page view.

### BACKGROUND INFORMATION

A page view of electronic content may be changed dynamically on an electronic paper display device. For example, a user may change a zoom level of a page view, which will change the amount of electronic content displayed (e.g., zooming in will display less text per page in a larger font). Because of the dynamically changing page view, layout of electronic content on an electronic paper display device may result in wasted space or whitespace.

### BRIEF DESCRIPTION OF THE DRAWINGS

The present invention, together with further objects and advantages, may best be understood by reference to the following description taken in conjunction with the accompanying drawings. It should be appreciated that the same reference numbers will be used throughout the drawings to refer to the same or like parts.

FIG. 1 is a schematic diagram of a system for electronic paper display whitespace utilization according to an embodiment;

FIG. 2 shows electronic content markup for electronic paper display whitespace utilization in accordance with an embodiment;

FIG. 3A shows a page view at a first zoom level implementing electronic paper display whitespace utilization according to an embodiment;

FIG. 3B shows a page view at a second zoom level implementing electronic paper display whitespace utilization according to an embodiment;

FIG. 3C shows a page view at a third zoom level implementing electronic paper display whitespace utilization according to an embodiment;

FIG. 4 shows a module for electronic paper display whitespace utilization in accordance with an embodiment; and

FIG. 5 is a flow chart illustrating electronic paper display whitespace utilization in accordance with an embodiment.

### DETAILED DESCRIPTION OF PREFERRED EMBODIMENTS

Certain embodiments of the present invention provide methods and systems for electronic paper display whitespace utilization. More particularly, certain embodiments of the present invention provide a system for and method of electronic paper display whitespace utilization which may dynamically insert appropriately sized portions of electronic content into one or more electronic content page views. Electronic paper display devices may permit user manipulation of one or more display attributes such as a zoom level, a scroll bar setting, or a focus. The manipulation of a user display attribute may affect the layout of electronic content on a page view. This may vary the amount of unutilized display space (e.g., space not used for primary electronic content). For example, a user reading electronic content (e.g., an article, book, periodical, or newsletter) may zoom in. This may cause a change in a page view of the electronic content resulting in a larger font and the display of less of the electronic content in the page view. This may also result in a larger amount of whitespace being displayed (e.g., below the article, below a hard page break, below a soft page break, to a side of a column, and above the article). According to an exemplary embodiment, the whitespace may be filled with one or more additional portions of electronic content such as, for example, advertisements.

Electronic paper display devices may be, by way of non-limiting example, a device utilizing an electronic paper display (referred to herein as “EPD”), such as electrophoretic displays or electro-wetting displays. Examples of such displays include those disclosed in, by way of example rather than limitation, U.S. Pat. Nos. 6,577,433, 6,529,313, 6,525,866, 6,574,034, 6,017,584, 6,067,185, 6,1 18,426, 6,120,839, 6,124,851, 6,130,774, 6,172,798, 6,177,921, 6,232,950 and 6,249,271.

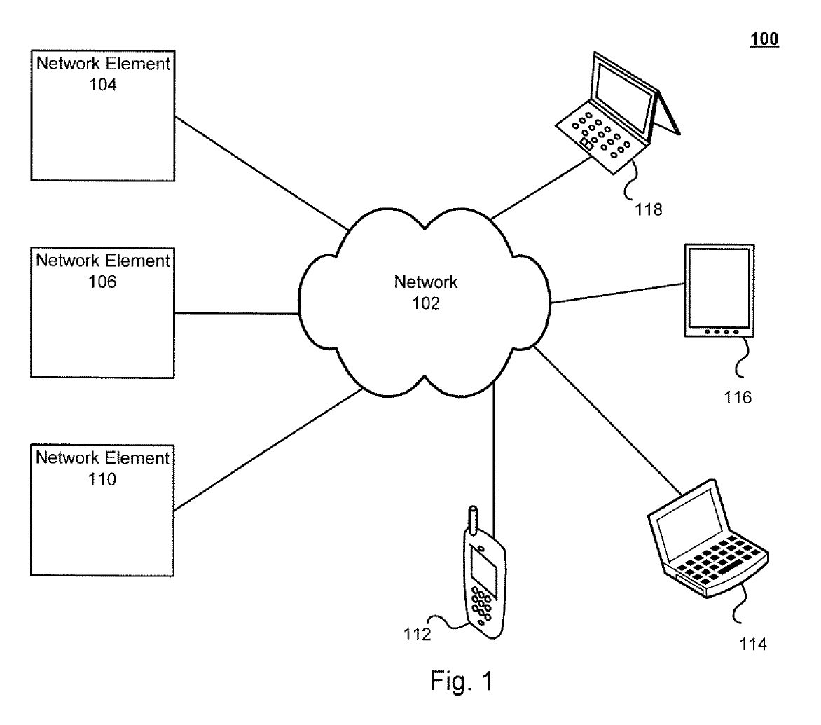

FIG. 1 is a schematic diagram of a system for electronic paper display whitespace utilization according to an embodiment. Network elements 104, 106, and 110 may be communicatively coupled to network 102. One or more of electronic paper display devices 112, 114, 116, and 118 may be communicatively coupled to network 102. In one or more embodiments, an electronic paper display device, such as electronic paper display device 116, may at times not be connected to a network.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n, and 802.11g or any other wired or wireless network that permits communication between network elements 104, 106, and 110, electronic paper display devices 112, 114, 116, and 118, and other devices communicatively coupled to network 102. In addition, network 102 may include, without limitation, telephone line, fiber optics, IEEE Ethernet 802.3, a Wide Area Network (“WAN”), a Local Area Network (“LAN”), or a global network such as the Internet. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a publisher's network, an electronic content provider network, corporate networks, and home networks.

In one or more embodiments, network 102 may be used to distribute electronic content. Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007; the contents of both applications are hereby incorporated by reference in their entireties.

Network elements 104, 106, and 110 may be servers, network storage devices or other devices communicatively coupled to network 102. In one or more embodiments, network elements 104, 106, and 110 may perform any, or a combination, of receiving electronic content display information, storing electronic content pagination and layout information, analyzing electronic paper display whitespace utilization, providing electronic paper display layout and/or formatting data to other components or devices, and providing additional electronic content. Network elements 104, 106, and 110 may also perform any, or a combination, of storing, receiving, transmitting, producing, aggregating, and uploading electronic content. Network elements 104, 106, and 110 may also perform other electronic content management functionality including, but not limited to any, or a combination, of account management, target marketing of electronic content to electronic paper display device users, user electronic content tracking, and content distribution. According to one or more embodiments, one or more portions of the above functionality may be performed by electronic paper display devices 112, 114, 116, and 118.

Network elements 104, 106, and 110 may contain or be communicatively coupled to storage, such as a Redundant Array of Inexpensive Disks (“RAID”), a Storage Area Network (“SAN”), an internet Small Computer Systems Interface (“iSCSI”) SAN, a Fibre Channel SAN, a Common Internet File System (“CIFS”), Network Attached Storage (“NAS”), a Network File System (“NFS”), tape drive based storage, or other computer accessible storage.

Network elements 104, 106, and 110 communicate with any, or a combination, of other systems, applications, and storage locations directly via one or more of an Application Programming Interface (“API”), a Remote Procedure Call (“RPC”), an interface table, a web service, an Extensible Markup Language (“XML”) based interface, a Simple Object Access Protocol (“SOAP”) based interface, a Common Object Request Broker Architecture (“CORBA”) based interface, and other interfaces for sending or receiving information. For example, network elements 104, 106, and 110 may communicate with accounting systems, marketing systems, Interactive Voice Response (“IVR”) systems, systems of content providers, or other systems, servers, or components to facilitate electronic content management, formatting, and layout.

According to some embodiments, network elements 104, 106, and 110 may each be responsible for different functionality in an electronic content distribution and management network. By way of non-limiting example, network element 104 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (“OCR”) processes. Other scanning processes may produce electronic content without performing OCR processes. Network element 104 may translate content from one format to another. For example, network element 104 may receive content from a subscriber and may translate the content into one or more electronic formats including, but not limited to, proprietary formats or industry standard formats (e.g., EPub (Electronic Publication)) utilized by one or more e-book readers. Network element 104 may receive subscriber or user content via emails, FTP (“File Transfer Protocol”), HTTP (“Hyper Text Transfer Protocol”), text message (e.g., via Short Message Service (“SMS”)), Multi-Media Messaging Service (“MMS”), Wireless Access Protocol (“WAP”), or via other electronic communication protocols. Categorization of content by network element 104 may include any, or a combination, of organizing content, storing content, and indexing content by one or more of a subject, subscription, and access. By way of non-limiting example, content may be grouped or stored in databases or other storage which may be separated according to subscription.

According to one or more embodiments, network element 104 may perform one or more additional functionalities. For example, network element 104 may contain or access one or more of user subscription information, accounting information, payment information, account identification, and statistics associated with user access to one or more portions of electronic content. Network element 104 may interface to other systems or components, either local or remote, such as accounting systems, Customer Relationship Management (“CRM”) systems, marketing systems, payment systems, authentication systems, network access servers, or other network systems or components. Network element 104 may monitor one or more accounts and may monitor access to electronic content stored on, distributed by or accessible from network 102 or one or more devices communicatively coupled to network 102. Account information may be provided to network element 104 or other network accessible components to generate usage information, verify transactions, or for other functionality. Subscription information, usage agreement information, and registration information obtained from a user of an electronic content network may contain demographic information, preference information, or other information which may be utilized for marketing purposes.

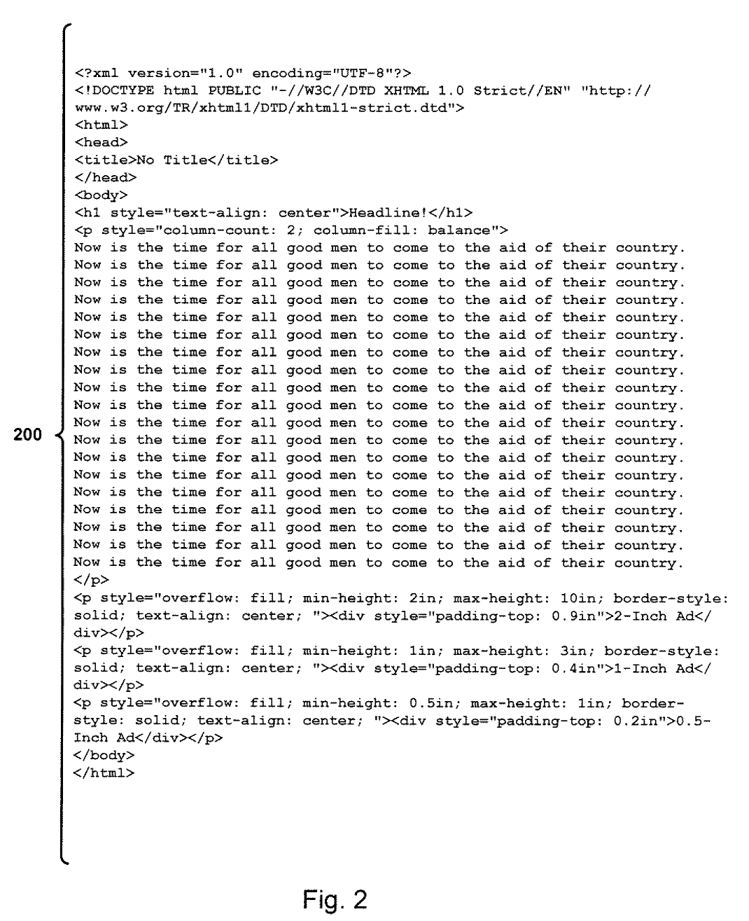

According to one or more embodiments, network element 106 may perform one or more of pagination, layout, and formatting of electronic content. Network element 106 may provide electronic content layout that may contain one or more optional elements in addition to the primary electronic content. For example, the primary content may be a story, an article, a book, a blog entry, or other electronic content that may be the focus of a particular electronic content file. In addition to the primary content, one or more optional elements may be included n markup, tags, or other electronic content formatting. The optional elements may include one or more of: advertisements, electronic messages, trivia, sports scores, news headlines, electronic content metadata, and a combination of the preceding. Network element 106 may provide information about the optional elements such as, for example, a minimum display size required, a maximum display size, or other metadata. This information about the one or more optional elements may be included in formatting, markup, and/or tags associated with the electronic content. Network element 106 may perform paginated content layout during publication of electronic content or subsequent to publication of electronic content. Formatting, markup, tags and other electronic content layout controls are discussed in further detail in reference to FIG. 2 below.

Electronic paper display devices 112, 114, 116, and 118 may be electronic book (“e-book”) readers, E-Ink® devices, desktop computers, laptop computers, wireline phones, mobile phones, Personal Digital Assistants (“PDA”), personal media players, gaming devices, or other devices capable of displaying electronic content. In one or more embodiments, electronic paper display devices 112, 114, 116, and 118 may access electronic content locally via one or more device interfaces.

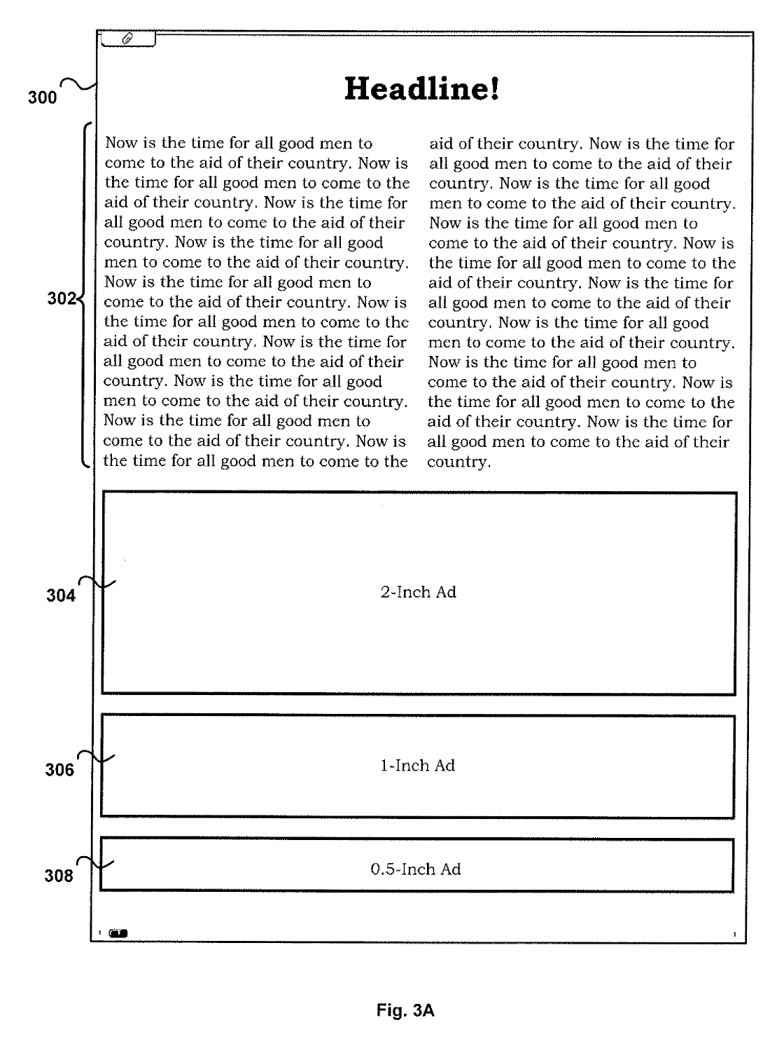

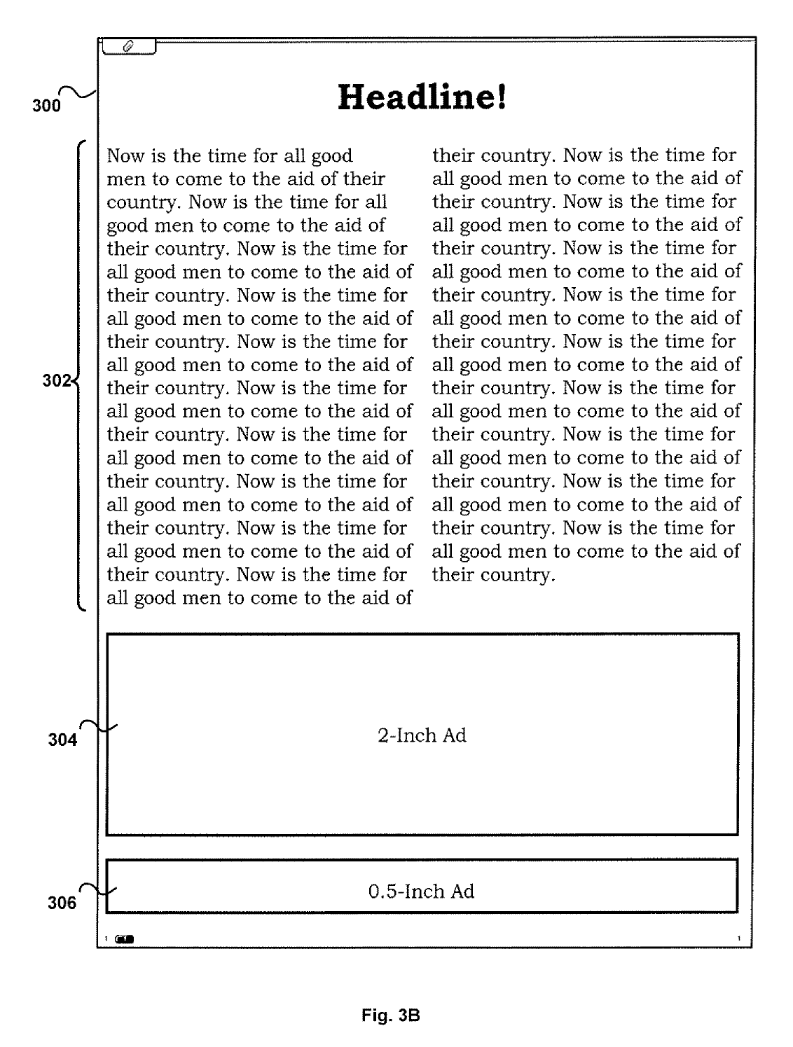

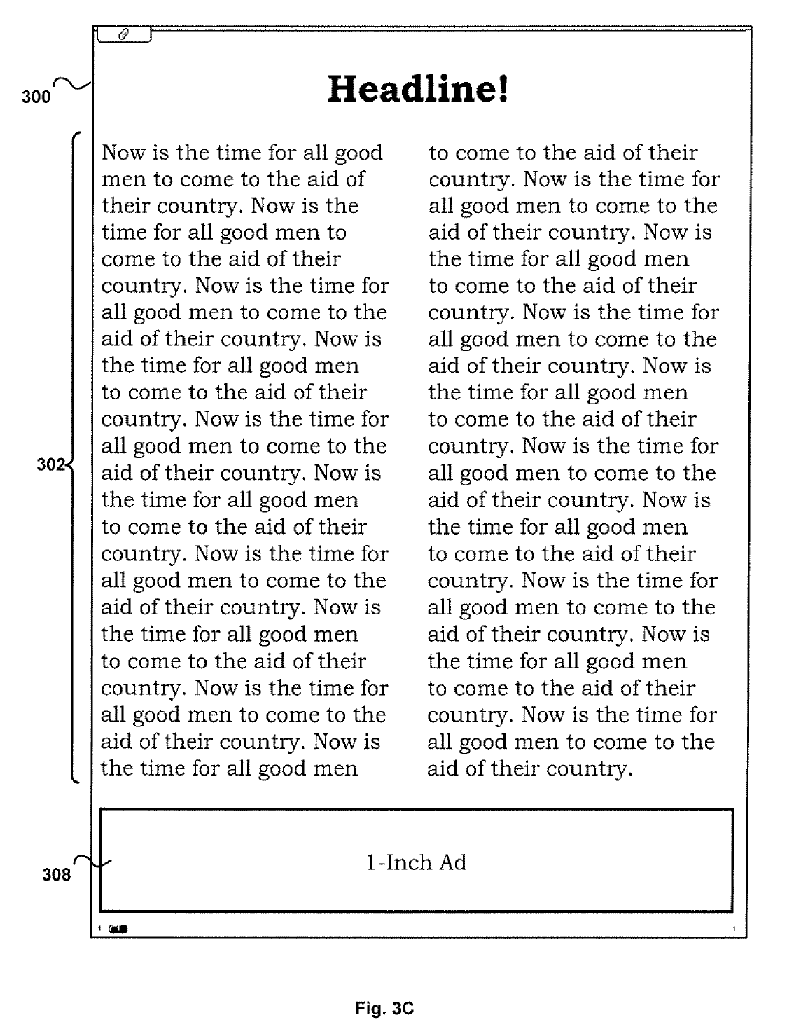

Electronic paper display devices 112, 114, 116, and 118 may perform one or more of rendering and displaying electronic content containing layout markup, tags, or other formatting control structures. Electronic paper display devices 112, 114, 116, and 118 may receive electronic content and may display electronic content using layout markup, tags, or other formatting control structures. Electronic paper display devices 112, 114, 116, and 118 may display only the primary electronic content, or the primary electronic content and one or more additional elements. According to some embodiments, the determination of whether to display one or more additional elements may be based at least in part on metadata provided in markup associated with the one or more elements. For example, electronic paper display devices 112, 114, 116, and 118 may identify whitespace available in a page view of electronic content during rendering of the content. The available whitespace may depend on a zoom level of the display. Electronic paper display devices 112, 114, 116, and 118 may compare the available whitespace with minimum size requirements or other metadata associated with the one or more additional elements specified in markup. Electronic paper display devices 112, 114, 116, and 118 may determine that the available whitespace has sufficient room to accommodate an additional element, such as an advertisement, and may include the additional element when rendering the page view of the electronic content. According to one or more embodiments, one or more of the determinations associated with whitespace utilization may be made on a network element, such as, for example, network element 106. Inclusion of additional elements to fill available whitespace is discussed in further detail in reference to FIGS. 3A, 3B, and 3C below.

According to some embodiments, electronic paper display devices 112, 114, 116, and 118 may access electronic content and receive and/or provide electronic content layout information via one or more network interfaces. Electronic paper display devices 112, 114, 116, and 118 may transmit and receive data to and from network 102 utilizing a standard telecommunications protocol or a standard networking protocol. By way of non-limiting example, one embodiment may utilize FTP (“File Transfer Protocol”), HTTP (“Hyper Text Transfer Protocol”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Transmission Control Protocol/Internet (“TCP/IP”) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. Electronic paper display devices 112, 114, 116, and 118 may use standard wireless protocols including IEEE 802.11 and 802.16. Electronic paper display devices 112, 114, 116, and 118 may also be connected to network 102 via protocols for a wired connection, such as an IEEE Ethernet 802.3.

By way of non-limiting example, electronic paper display devices 112, 114, 116, and 118 may contain one or more interfaces including, a USB (“Universal Serial Bus”) connection, an RS-232 or serial connection, a Bluetooth connection, an RFID (“Radio Frequency IDentification”) reader or interrogator, an RFID tag (active or passive), a firewire connection, or interfaces supporting storage media (e.g., flash memory cards, CDs, DVDs).

Network element 110 may provide electronic content to electronic paper display devices 112, 114, 116, and 118. Network element 110 may also collect information from electronic paper display devices 112, 114, 116, and 118, such as inclusion of or views of one or more optional additional elements. According to some embodiments, content of optional elements may be replaced periodically. The one or more additional elements contained in markup of electronic content may be stored separately for potential rendering and only a reference to optional elements may be included in the markup. Network element 110 may periodically provide, refresh, or update optional elements for potential inclusion into page views. For example, electronic paper display devices 112, 114, 116, and 118 may cache or request optional elements for inclusion into page views of electronic content. Certain optional elements may be time sensitive or may expire (e.g., coupons, sales, news, sports scores, etc.). Optional time elements may be updated, refreshed, expired or otherwise manipulated based upon one or more marketing criteria. For example, if a specified category of optional element has had a positive response, more optional elements from that category may be provided (e.g., if a user clicked on an ad for a particular category of merchandise, more ads for that merchant or that product category may be included.). According to some embodiments, the selection of optional elements provided by network element 110 may depend on a marketing agreement, such as an agreement with an electronic content provider, a network service provider, or other business entity.

According to one or more embodiments, electronic content may be published or provided using markup formatting such as XML (“eXtensible Markup Language”) or Cascading Style Sheets (CSS). For example, electronic content may be provided using an Open Publication Structure (“OPS”) standard, such as OPS 2.0. The use of markup language extensions may allow appropriately sized content (e.g., additional optional elements) to be inserted into areas, such as at the end of pages, which may otherwise be blank. Different content may be selected based on an actual paginated layout so that a tightly populated, fully paginated layout may be created. The content chosen for insertion may dynamically vary based upon the screen size of the target reading device or “zoom-state” (stepped increase of ambient font size from markup-specified base size of preceding text on the page) or based on other user interface display characteristics. According to some embodiments, one or more of these techniques may be used to provide advertising placement in paginated newspaper or magazine layouts presented on an electronic paper display device with multiple zoom-states. This may allow placement of advertising in one or more available zoom-states and may fill available page-end whitespace, creating attractive layouts, without pushing ads onto subsequent pages that would otherwise contain only the ad(s) and additional whitespace.

One or more portions of whitespace utilization may be performed on a network element such as network element 104, 106, and 108. For example, the calculation of the placement of the inserted content may be performed by a content layout engine. This may be run on a network element such as a server at the time of content layout compilation. The rendering of inserted content may be performed by one or more components of electronic paper display devices 112, 114, 116, and 118, such as device-based reading system client software.

According to some embodiments, whitespace utilization may be used to fill one or more areas of a page that may otherwise be blank such as for example, before a hard page break, a soft page break, or at other blank locations. At any place that such a blank spot or whitespace might appear markup language or other formatting controls such as, for example, one or more xhtml elements (e.g., pictures, or another box or table structure), may be added in the content flow (based upon available remaining space in the page view at a current zoom-state). Elements to be inserted may be identified the CSS “overflow” property value of “fill” (“overflow: fill”) and may use the CSS min-height and/or max-height properties specify insertion available space requirements. When such a box is encountered, if the available space it greater than the “min-height” and less than the “max-height,” then the object may be placed, otherwise the object may be hidden. For example:

<p style=“overflow: fill; min-height: 1 in”>A</p>

may cause an “A” to be displayed only if there were at least one inch of available whitespace remaining on the page.

Processing of elements may continue until one or more elements are placed or none can fit on the current page. At that point, a page break may occur and any remaining “overflow. fill” elements that may have been placed at the top of the next page may be discarded. This may allow content creators to fill empty space with 1 or more elements, of varying size to best fill the area, while still allowing multiple layouts. Note that the number and size of chosen “fill” items may vary to provide placement options for each processed zoom-state. This may allow different items to appear in different zoom-states.

Referring to FIG. 2, electronic content markup for electronic paper display whitespace utilization is shown according to an exemplary embodiment. FIG. 2 may be an exemplary multi-zoom-state markup. The markup of FIG. 2 may provide the three exemplary one-page layouts as shown in FIGS. 3A, 3B, and 3C. The “<p style=”overflow: fill>” paragraph tags may be exemplary optional elements of varying sizes (i.e., min-heights specified of one-half inches, one inch, and two inches) which may be included depending on available whitespace on a rendered page.

Referring to FIG. 3A a page view is shown at a first zoom level implementing electronic paper display whitespace utilization. FIG. 3SA may represent a page view in display 300 at a normal or default zoom level. The page view may include primary content 302 and optional elements 304, 306, 308. Optional element 304 may be a two inch box containing an advertisement or other optional content. Optional element 304 may be a two inch ad requiring a minimum height of two inches as specified in the exemplary markup of FIG. 2. Optional element 304 may be a two inch box containing an advertisement or other optional content. Optional element 304 may be a two inch ad requiring a minimum height of two inches as specified in the exemplary markup of FIG. 2. Optional element 306 may be a one inch box containing an advertisement or other optional content as specified in the exemplary markup of FIG. 2. Optional element 308 may be a one-half inch ad requiring a minimum height of one-half inch as specified in the exemplary markup of FIG. 2. At a normal or default zoom state all three ads included as optional elements in the markup of FIG. 2 may be rendered and/or displayed.

Referring to FIG. 3B, a page view at a second zoom level implementing electronic paper display whitespace utilization is shown. FIG. 3B may “zoomed in” and may contain an increased font size. The page view may include primary content 302 and optional elements 304 and 306. At this zoom level, optional element 308 may not be rendered and/or displayed.

Referring to FIG. 3C a page view at a third zoom level implementing electronic paper display whitespace utilization is shown. FIG. 3C may contain an even larger font size than 3B. The page view may include primary content 302 and optional element 304. At this zoom level, optional elements 306 and 308 may not be rendered and/or displayed.

Other user interface display controls may also affect which optional elements are included. For example, if electronic content is displayed in a window and a user resizes the window different optional elements may be included depending on available whitespace and other factors. Additional user interface controls may include scrolling or other user inputs.

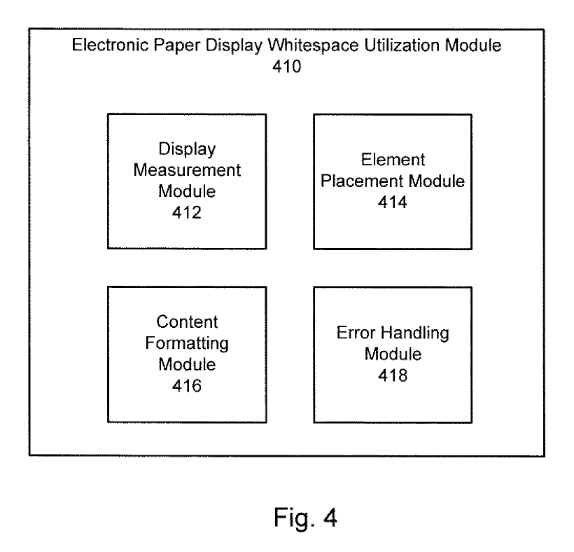

FIG. 4 shows electronic paper display whitespace utilization module 410 in accordance with an embodiment of the present disclosure. Electronic paper display whitespace utilization module 410 may contain one or more components including display measurement module 412, element placement module 414, content formatting module 416, and error handling module 418. One or more portions of electronic paper display whitespace utilization module 410 may be located on a user device, such as an electronic paper display device. According to some embodiments, one or more portions of electronic paper display whitespace utilization module 410 may be located on a network.

According to one or more embodiments, display measurement module 412 may monitor a zoom level, available whitespace, and other user interface display characteristics.

Element placement module 414 may utilize metadata about one or more optional elements associated with content formatting data. Metadata may include, for example, size requirements of an optional element. Element placement module 414 may compare metadata about one or more optional elements with data provided by display measurement module 412 in order to identify one or more elements to include in a rendered or displayed page of electronic content.

Content formatting module 416 may markup, tag, format, or otherwise structure electronic content to include one or more optional elements that may be displayed with the primary electronic content of a page view. For example, content formatting module 416 may process a Cascading Style Sheet (CSS) that may be applied to an XHTML (eXtensible Hypertext Markup Language) document. According to some embodiments, the formatted electronic content produced by content formatting module 416 may include the use of CSS “overflow” property values of “fill” (“overflow: fill”) and may use the CSS min-height and/or max-height properties specify insertion available space requirements for one or more optional elements.

Error handling module 418 may handle errors associated with electronic content formatting for an electronic paper display device. Error handling module 418 may log errors, send notifications, or perform corrective actions. For example, error handling module 418 may discard optional elements for which there is not adequate display space in a page view. Error handling module 418 may also provide notifications such as text messages or emails if a device error is detected.

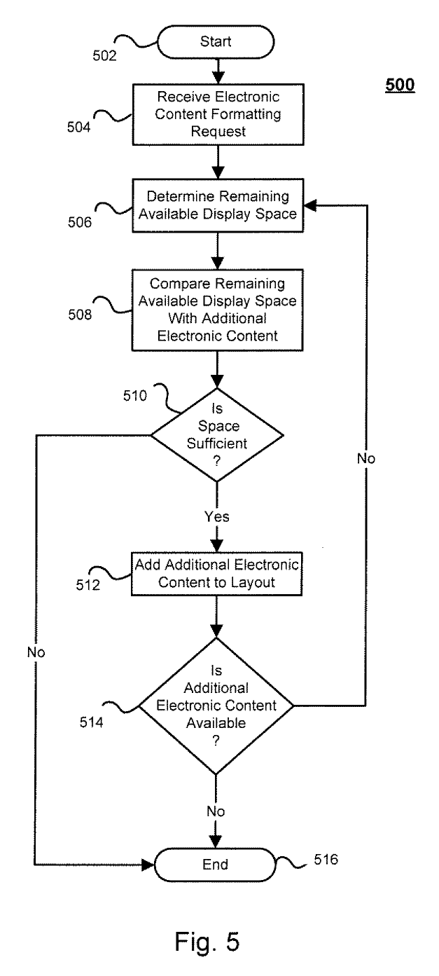

FIG. 5 is a flow chart illustrating electronic paper display whitespace utilization in accordance with an embodiment according to an embodiment. At block 502, the method 500 for whitespace utilization, in accordance with an exemplary embodiment, may begin.

At block 504, the method 500 may receive an electronic content formatting request. For example, a user may request the layout of a page of electronic content (e.g., opening a file, clicking on a link, double-clicking on an icon, etc.). A request may include updating a display based on a user interface change (e.g., zooming in, zooming out, etc). The method 500 may retrieve the electronic content which may be formatted with tags, markup language, or other layout control data structures.

At block 506, the method 500 may calculate, for current display characteristics such as a zoom level, the available whitespace on a page view containing the primary electronic content. The available whitespace may be after a page break in the display of the primary electronic content (e.g., the requested content), or in another portion of the page layout.

At block 508, the method 500 may compare the available whitespace with metadata associated with one or more optional display elements. The metadata may be contained in markup of the electronic content. For example, CSS “overflow” property values of “fill” (“overflow: fill”) may be included and may use the CSS min-height and/or max-height properties specify insertion available space requirements for one or more optional elements.

At block 510, the method 500 may determine if available whitespace is sufficient for one or more elements. If available whitespace is sufficient, the method 500 may continue at block 512. If available whitespace is not sufficient, the method may end at block 516. According to some embodiments, method 500 may iterate through one or more available optional elements to determine a minimum of the minimum required heights of the optional elements prior to ending. According to some embodiments, the optional elements may be ordered by minimum required height and the method 500 may iterate through one or more optional elements until an appropriate optional element is found or until all available optional elements have been considered. For example, an optional element with the largest minimum required height may be evaluated first and if there is not adequate whitespace available for this element, the method may iterated through optional elements with successively smaller minimum height requirements. Other algorithms may be utilized.

At block 512, an appropriate optional element may be included. According to some embodiments, identified space requirements of an optional may be provided to a second process or component which may select an optional element conforming the space requirements based on one or more additional factors. For example, it may have been determined that available whitespace can accommodate an advertisement or other optional element with a minimum height requirement of one inch. One or more additional factors, such as marketing factors, may be utilized to identify an appropriate one inch ad, which may be locally stored.

At block 514, the method 500 may determine whether additional electronic content is available. If additional electronic content or optional elements are available, the method may return to block 506 for further processing. If additional electronic content or optional elements are not available, the electronic content may be rendered and/or displayed. At block 516, the method may end.

The description above describes one or more devices including user devices, a communication network having network elements that are coupled to each other via one or more links (e.g., physical or logical, a communication network, and other elements for coupling users to the communication network, some of which are explicitly depicted, others of which are not. As used herein, the term “module” may be understood to refer to executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein may be tangibly embodied in one or more physical media, such as, but not limited to, a Compact Disc (“CD”), a Digital Versatile Disc (“DVD”), a floppy disk, a hard drive, Read Only Memory (“ROM”), Random Access Memory (“RAM”), as well as other physical media capable of storing software, or combinations thereof. Moreover, the figures illustrate various components (e.g., servers, computers, etc.) separately. The functions described as being performed by various components may be performed by other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A hardware implemented method for electronic paper display device content formatting, the method comprising:
receiving an electronic request to format electronic paper display device content at an a network accessible device;
determining remaining available display space on a page view of a electronic paper display associated with an electronic paper display device;
identifying additional electronic content for inclusion in the page view based at least in part on a comparison of one or more attributes of the additional electronic content with the determined remaining available display space; and
adding the identified additional electronic content to the page view.

2. The method of claim 1 wherein the network accessible device comprises at least one of: a server, an electronic paper display device, and a combination of the preceding.

3. The method of claim 1, wherein the determination is made based at least in part on a display state of the electronic paper display device.

4. The method of claim 3, wherein the display state comprises a zoom level.

5. The method of claim 1, wherein the identified additional electronic content comprises electronic content associated with a page layout of the electronic content.

6. The method of claim 5, wherein the identified additional electronic content is associated with a page layout using a markup language.

7. The method of claim 6, wherein markup language comprises XML and the additional electronic content is associated using one or more optional display elements.

8. The method of claim 7, wherein the one or more optional display elements are associated using cascading style sheets overflow property value settings.

9. The method of claim 1, wherein adding the identified additional electronic content to the page view comprises rendering the electronic content for display.

10. The method of claim 1, wherein the additional electronic content for inclusion in the page view comprises one or more advertisements.

11. The method of claim 1, wherein the additional electronic content for inclusion in the page view comprises at least one of: electronic messages, trivia, sports scores, news headlines, electronic content metadata, and a combination of the preceding.

12. The method of claim 1, wherein determining remaining available display space on a electronic paper display device page view comprises measuring whitespace remaining after calculating layout of primary electronic content.

13. The method of claim 12, wherein primary electronic content comprises content selected for display on the electronic paper display device.

14. The method of claim 1, wherein the remaining available display space on a electronic paper display device page view comprises space remaining on a page view after a page break of primary electronic content.

15. At least one processor readable storage medium for storing a computer program of instructions configured to be readable by at least one processor for instructing the at least one processor to execute a computer process for performing the method as recited in claim 1.

16. An electronic paper display device comprising:
electronic paper display for displaying electronic content;
a communications module for receiving electronic content; and
a processor communicatively coupled to the electronic paper display and the communications module, wherein the processor is configured to:
receive an electronic request to format electronic paper display device content;
determine remaining available display space on a page view of the electronic paper display associated with the electronic paper display device;
identify additional electronic content for inclusion in the page view based at least in part on a comparison of one or more attributes of the additional electronic content with the determined remaining available display space; and
add the identified additional electronic content to the page view.

17. The electronic paper display device of claim 16, wherein the determination is made based at least in part on a display state of the electronic paper display device.

18. The electronic paper display device of claim 16, wherein the display state comprises a zoom level.

19. The electronic paper display device of claim 16, wherein the identified additional electronic content comprises electronic content associated with a page layout of the electronic content.

20. The electronic paper display device of claim 19, wherein the identified additional electronic content is associated with a page layout using a markup language.

21. The electronic paper display device of claim 20, wherein markup language comprises XML and the additional electronic content is associated using one or more optional display elements.

22. The electronic paper display device of claim 21, wherein the one or more optional display elements are associated using cascading style sheets overflow property value settings.

23. The electronic paper display device of claim 16, wherein adding the identified additional electronic content to the page view comprises rendering the electronic content for display.

24. The electronic paper display device of claim 16, wherein the additional electronic content for inclusion in the page view comprises one or more advertisements.

25. The electronic paper display device of claim 16, wherein the additional electronic content for inclusion in the page view comprises at least one of: electronic messages, trivia, sports scores, news headlines, electronic content metadata, and a combination of the preceding.

26. The electronic paper display device of claim 16, wherein determining remaining available display space on a electronic paper display device page view comprises measuring whitespace remaining after calculating layout of primary electronic content.

27. The electronic paper display device of claim 26, wherein primary electronic content comprises content selected for display on the electronic paper display device.

28. The electronic paper display device of claim 16, wherein the remaining available display space on a electronic paper display device page view comprises space remaining on a page view after a page break of primary electronic content.
